(19) United States
(12) Patent Application Publication
(10) Pub. No.: US 2021/0374653 A1
(43) Pub. Date: Dec. 2, 2021

(54) SYSTEMS AND METHODS FOR DYNAMIC AND COLLABORATIVE CAREER CAPITAL MANAGEMENT WITHIN ENTERPRISES

(71) Applicant: Jiva360, Inc., Vienna, VA (US)

(72) Inventor: Victoria Draude, Vienna, VA (US)

(21) Appl. No.: 17/335,247

(22) Filed: Jun. 1, 2021

Related U.S. Application Data
(60) Provisional application No. 63/031,570, filed on May 29, 2020.
(60) Provisional application No. 63/076,553, filed on Sep. 10, 2020.

(51) Int. Cl. G06Q 10/06; G06Q 10/10

(52) U.S. Cl. CPC G06Q 10/063118; G06Q 10/105

(57) ABSTRACT

Raw profile information for a member of an enterprise may be accessed with at least one of a system server and a career capital management agent. Profiles in a profile repository may be accessed to identify career track relevant elements (“CTR-elements”) from the raw profile information. CTR-elements associated with the member may be incorporated into a member's active profile stored in at least one of the system server and an enterprise server. Career action data, including positions and development offerings, may be identified from the enterprise server or an external service based on career tracks of the active profile and the CTR-elements. The career action data may be integrated into manager and member versions of the active profile based on the CTR-elements and a visibility setting for the active profile, which may be configured within the manager version of the active profile.

### CROSS REFERENCE TO RELATED APPLICATIONS

This application claims the benefit of priority under 35 U.S.C. § 119(c) to U.S. Provisional Patent Application No. 63/031570 entitled “SYSTEMS AND METHODS FOR EMPLOYEE AND EMPLOYER DRIVEN HUMAN CAPITAL MANAGEMENT WITHIN ORGANIZATIONS,” filed May 29, 2020, and to U.S. Provisional Patent Application No. 63/076553 entitled “SYSTEMS AND METHODS FOR DYNAMIC AND COLLABORATIVE CAREER CAPITAL MANAGEMENT WITHIN ENTERPRISES,” filed Sep. 10, 2020, both of which are incorporated by reference in their entireties for all purposes.

### BACKGROUND

Enterprises—large organizations having employees numbering in the thousands or more—are often so large that a continuous and always-changing internal job market persists within each enterprise. This is true for large organizations focused on hospitality services such as large hotel chains, software and consumer electronic companies, national cellular and utility service providing companies, and the like. Another example where this is the case is in the consulting industry. In that industry, large organizations employ talented individuals, often times with generalist backgrounds, to staff short and long term contracts with significant clients such as the federal government, as well as state and foreign governments. These clients may also include large commercial entities attempting to implement company-wide initiatives to reduce inefficiencies, revamp information technology (“IT”) systems, change respective working cultures, implement new management strategies, or other such projects.

Staying with the consulting industry, large consulting enterprises often win multi-year and multi-consultant contracts with these types of significant clients based on past performances and/or a given organization's reputation to staff such contract engagements with high quality individuals (e.g., management, IT, government contract, and other types of consultants with varying degrees of subject-matter expertise). The types of large organizations that bid on the above-mentioned contracts may, once a contract or program is awarded, employ multiple strategies for filling staffing requirements on the contract or program. This may include selecting from a pool of current employees, as well as hiring new employees specifically for that contract. In some examples, an employee of the organization may need to have a particular skill sets, certifications, registrations, or completed specific training programs to be eligible for some of the positions of the contract or program.

Having visibility into which current employees possess the needed skill sets, certifications, registrations, and/or training is a challenge for large organizations for all of the types mentioned above. The sizes of these enterprises simply do not allow those in charge of filling open positions (contract, program, or internal) to reliably know whether the organization already employs the right personnel for one or more of these positions. In addition, pertinent employee information may be spread across different and disparate company-wide systems that are not integrated, or otherwise operate independently of one another.

Returning to the consulting industry, though many employees are in salaried positions, there are many similarities between these regular employees in large consulting companies and independent contractors. In other types of large organizations (software, utility, and hotel), especially where employees do not use an intranet on a daily basis, it is very difficult to know who is available and what positions and internal training opportunities are available. Thus, in an enterprise of any of the types previously mentioned it may be entirely left to the employee to develop certain skills, obtain certain certifications and registrations, and/or take particular training courses. Career paths for these employees are more often than not left to the employee, to chart out and ensure alignment with certain objectives of the organization.

As a result, a need exists for methods and systems that facilitate dynamic, collaborative, employee-driven, and employer-driven career capital management across different types and sizes of organizations including enterprises.

### SUMMARY

Examples described herein include systems and methods for causing, with a server, a career capital management agent (“CCM agent”) to be implemented on at least one of a system server and a user device. In one example, raw profile information (“raw info”) for a member of an enterprise may be accessed with at least one of the system server and the CCM agent. A first profile repository may be accessed to identify career track relevant elements (“CTR-elements”) of information from the raw info based on reference profiles included in the profile repository.

In one example, CTR-elements associated with the member may be incorporated into an active profile for the member, which may be stored in at least one of the system server and an enterprise server. At least one of the enterprise server and an external service may be accessed and career action data identified based on active career tracks of the active profile and the CTR-elements. In one example, the career action data may include positions and development offerings for the enterprise. In another example, the career action data may be integrated into enterprise and member versions of the active profile based on the CTR-elements and a visibility setting for the active profile. In another example, the visibility setting may be configured within a manager version of the active profile.

Examples described herein may provide dynamic, collaborative, employee-driven, and employer-driven career capital management across different types and sizes of organizations including enterprises—large organizations having employees numbering in the thousands or more. In addition, examples described herein include systems and methods for facilitating varying degrees of visibility into open positions, available training opportunities that support chosen career tracks, and how to steer certain individuals to obtain career capital and pursue career progressions that align with an enterprise's goals.

Examples of the disclosure will be apparent to those skilled in the art from consideration of the specification and practice of the examples disclosed herein. Though some of the described methods have been presented as a series of steps, it should be appreciated that one or more steps may occur simultaneously, in an overlapping fashion, or in a different order. The order of steps presented are only illustrative of the possibilities and those steps may be executed or performed in any suitable fashion. Moreover, the various features of the examples described here are not mutually exclusive. Rather any feature of any example described here may be incorporated into any other suitable example. It is intended that the specification and examples be considered as exemplary only, with a true scope and spirit of the disclosure being indicated by the following claims.

### BRIEF DESCRIPTION OF THE DRAWINGS

FIG. 1 is a flowchart of an example method for managing enterprise career capital.

FIG. 2A is a sequence diagram of an example method for building and updating active profiles of enterprise members and associating active profiles with enterprise programs.

FIG. 2B is a sequence diagram of an example method for providing access to an active profile for a member or a group of active profiles for a program.

FIG. 3 is a flowchart of an example method for building or updating an active profile(s) with career track-relevant elements (“CTR-elements”).

FIG. 4 is a flowchart of an example method for measuring and characterizing potential impacts to an enterprise from member attrition using a system of the present disclosure.

FIG. 5 is an illustration of exemplary systems components for managing enterprise career capital.

FIG. 6 is an illustration of an example graphical user interface (“GUI”) of a career management page for a member module or a manager module in a member mode, that may be used to perform the various methods described herein.

FIG. 7 is an illustration of an example GUI for a career track page for a member module or a manager module in a member mode.

FIG. 8 is an illustration of an example GUI of a program information page for a manager module, in a program mode, that may be used to perform the various methods described herein.

FIG. 9 is an illustration of an example GUI of an employee summary page for a manager module in a program mode according to the present disclosure.

FIG. 10 is an illustration of an example GUI of an attrition report page for a manager module in a program mode.

FIG. 11 is an illustration of an example GUI of a career track summary page for a manager module in a program mode.

FIG. 12 is an illustration of an example GUI for of a mobility report page for a manager module in a program mode.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

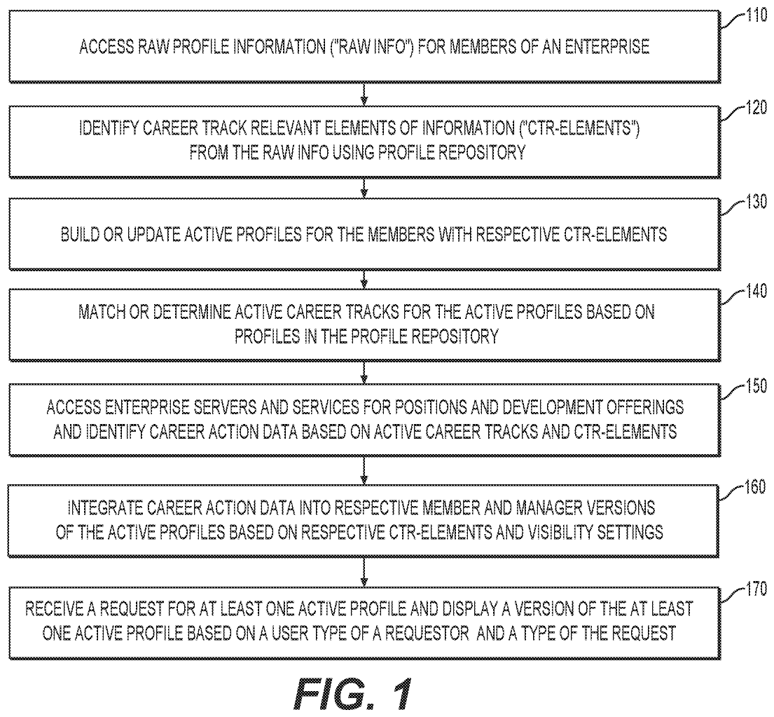

Turning to FIG. 1, an example method for dynamically and collaboratively managing enterprise career capital is illustrated, and includes accessing raw profile information (referred to hereafter as “raw profile information” or “raw info”) for members of an enterprise in stage 110.

Raw profile information may include an employment history for the member. Raw info may include member evaluations (in total), as well as feedback provided by a member at various times in their history. Raw info may include any information related to employment, skill development, certification acquisition, educational records, or any other information that may be understood as generally relevant to, or a requirement for, employment and career progression. However, raw info includes this information prior to being identified or otherwise assigned to a category or given a particular designation that may be used for grouping or searching similar information within assimilations of information specific to members or groups of members of an enterprise.

In one example, the raw info is accessed by an agent being implemented on user devices used by members of the enterprise or a management server for the enterprise. The agent may be specifically configured to facilitate career capital management (“CCM”) by members and managers using a computing infrastructure of an enterprise. The raw info may be stored on the user devices and/or the server, and accessed by the agent (hereafter referred to as “CCM agent”) according to certain permissions established with the enterprise for a system configured to control, implement, install, and/or maintain the CCM agent on the user devices and/or enterprise servers. In one example, the system includes a system backend including one or more servers configured to communicate with the enterprise servers and/or the user devices over a network, such as the internet for example. In another example, the raw info may be accessed by a CCM service being implemented by the system backend.

In one example, the CCM agent may include a device-level component, such as an API, device system-specific application, or virtualized device, and an application-level component, such as an API, SDK, or application wrapper. The device-level component may include system level privileges for a user device or an enterprise backend. The application-level component may include privileges in certain applications, such as a web- or dedicated-records system application, which may be developed for operation with one or both of device and records system backends. Reference to the CCM agent is understood to include either or both of the device-level and application-level components unless otherwise specified.

The CCM service may include an application or other administrator tool executed on a server for a system according to the present disclosure. The CCM service may control or otherwise coordinate communication and transfer of information between the system backend, user devices, an enterprise backend, and other systems. Further, the CCM service may support, manage, direct, and/or facilitate operations of system components operating within a computing system infrastructure of an enterprise.

In another example, the raw info is received through a user interface for a user device or, in the case of an enterprise server, through a user interface of a computing device operated by an administrator for the enterprise. The computing device may be the enterprise server or another computing device used specifically to manage operations of the enterprise server.

The CCM application may include or deploy different modules on user devices. In one example, the CCM application may be a web application that is accessed on demand by members. In another example, the CCM application may be a dedicated application installed on the user devices. The modules may include graphical user interface (“GUI”) pages or groups of pages (e.g., GUI consoles, dashboards, etc.) specifically configured to present, and allow a member to query their own, or a manager groups of, active profiles according to CTR-elements that are the focus of the query.

At stage 120, career track relevant elements of information (“CTR-elements”) are identified and extracted from the raw info. In one example, a CCM agent being implemented on a user device used by a member, or a computing device used to manage enterprise server operations, accesses a profile repository to determine what portions of the raw info qualify as CTR-elements. In one example, with regards to those position titles included in the raw info, this process may include removing, identifying and flagging for no action, ignoring, or generating a temporary profile that omits. This may be accomplished without removing information identifying one or more programs and/or managers that a member is a part of or managed by. In another example the CCM agent may remove the position or title information, or otherwise isolate all the raw information that does not include positions or titles, and transmit this intermediate version of raw info to a CCM service being implemented by a system backend.

The CCM agent or the CCM service may compare the raw info to elements of repository profiles in stage 120. The repository profiles may include elements which are categorized, flagged, or assigned according to a type of CTR-element each element represents. Types of CTR-elements are described immediately below. In one example, the CCM agent or the CCM service may parse the raw info into elements for matching with elements in the repository profiles. In another example, the raw info may include some type of information that the CCM agent or the CCM service recognizes as a way to limit the types of CTR-elements that may be included in the raw info. For example, the raw info may include a total number of years of experience for a member. With this information, the CCM agent or the CCM service may be able to limit the types of CTR-elements it looks for to only those that represent certifications, skills, clearances, and the like that do not require more time to acquire than a total amount of experience for a member that is the subject of the raw info being analyzed in stage 120.

In one example CTR-elements may include information regarding enrollment for, progression with, or completion of: degrees and/or certifications (e.g., for completing, mastering, or passing an examine related to software, areas of technology, process management, six sigma, leadership, vocational skills, etc.); enterprise development opportunities including internal or enterprise-sponsored external training; security clearance processes; work authorization processes; and immigration processes (as they relate to a member's ability to work on certain matters). CTR-elements will likely include, when applicable, current programs and managers the member is involved with and managed by respectively. Further, CTR-elements may include past programs and managers for the member.

In addition, CTR-elements may include: past, current, and projected compensation; past and current performance evaluations/ratings; goals identified by, for example, a first member or a second member that supervises the first member, and are related to performance goals and/or needed or desired certifications, skills, competencies, and/or training; information from self-evaluations; areas of interest related to professional development; areas of interest related to certain markets or areas of business or technology; skill assessments and/or efficiency ratings; skill matrices; core and secondary competencies; and/or results from internal subject-matter competency exams and/or enterprise-administered/sponsored surveys. Still further, CTR-elements may include: information regarding current contracts or programs on which a member is allocating time; competency requirements for current contracts and which competencies a member provides; current and future availability; geographic location; geographic location preferences; time allocations to certain areas (e.g., government contracts, commercial contracts, business development); and/or contract end dates after which a member may not be on a contract. In other examples, CTR-elements may include sales data such as sales made or leads generated by a member; sales goals reached; total revenue generated; revenue to salary ratio; and/or efficiency ratings. In still other examples, CTR-elements may include information about: a member's areas of expertise generally; goals; job responsibilities; areas of expertise and markets served and/or targeted by, a group or unit of an enterprise of which a member is a part; and/or a group or unit of an enterprise that a member has expressed interest in joining or been recommended for.

In stage 130, active profiles for members of an enterprise may be built or updated on a system and/or enterprise backend database or storage medium. The raw info accessed or received in stage 110 may pertain to one member or several members. Stage 120 involves identifying one or more packages of CTR-elements, and associating each package of CTR-elements to a member that is uniquely associated with information represented in that package of CTR-elements. Each applicable active profile that is built or updated in stage 130 may be uniquely associated with one member of an enterprise. Thus, in stage 130 each package of CTR-elements may be used to create or build an active profile for a member uniquely associated with the package of CTR-elements, or used to update an existing active profile that is uniquely associated with the same member associated with the package of CTR-elements.

It will be noted that active profiles may include position titles for members for the purposes of searching or sorting. Further, CTR-elements may include these position titles especially for an active profile that does not include a member's current position title. However, one objective of the systems and methods described herein, is to build profiles of information that best reflect member's capabilities, competencies, and/or acumen for certain types of job responsibilities, independent of any position or title. A further objective is to use this position/title independent information as a foundation for plotting or modifying career tracks to be able to better align career track projections with enterprise business objectives (from an enterprise standpoint) while enabling members to better meet goals to achieve professional aspirations.

Stage 130, in one example, may include extracting discrete elements of CTR-elements (e.g., a new certification, security clearance, skill rating, etc.) and adding these elements to specific fields in an active profile. In another example, these elements may be tagged based on the type or category of information they represent. In one example, categories may correspond to exemplary types of CTR-elements as previously discussed.

At stage 140, a CCM service operating on a system backend, or a CCM agent being implemented on an enterprise backend, or an enterprise managed or partially managed device may analyze one or more active profiles built or updated in stage 130, and determine career tracks that may be included therein. In one example, similar to stage 120, repositories of active or archived profiles may be accessed and compared to the active profiles being analyzed in stage 140.

A CCM service or agent may implement machine learning to match individual or groups of CTR-elements to corresponding elements in the repository profiles to recognize patterns.

For example, the system, through a CCM service or agent or other component, may recognize that members having a profile including certain combinations of certifications, skills, performance ratings, and/or clearances at one point in their history, go on to acquire certain other skills, certifications, clearances, subject-matter expertise, and/or position responsibilities. The combinations of potential future skills and qualifications define potential career progressions that the system may match to members based on CTR-relevant elements currently in their active profile.

In addition, career tracks for a member may be identified based on goals or needs of a group, unit, contract, or program that the member is a part of, and for which the member has a minimum level of requirements. For example, a group of an enterprise may be set to enter a market that requires its workforce to have certain software, regulatory, or skill-based certifications to even be competitive in acquiring contracts in that market. The system of the present disclosure may match a member with a career track that involves obtaining all four required certifications based on: that member having already acquired two of the four certifications; a recent enterprise survey completed by the member; and additional factors as reflected in that members active profile.

Thus, in one example, stage 140 may include the CCM service identifying one skill or certification needed for the member to progress further on a particular career track. In addition, stage 140 may include determining percentage of a career track that has been completed by the member. Continuing with the four certification example above, based on the member having two of the certifications, a particular number of years of experience, involvement in a particular number of matters or contracts, difficulty and/or time required to obtain the remaining certifications, and other factors, a CCM service or agent may determine that the member has completed 63% of the career track in question.

At stage 150, a CCM service or agent may access enterprise servers and query for positions and development offerings that are required for, would be beneficial to, or are otherwise consistent with progression in the one or more career tracks added to an active profile in stage 140. Many enterprises implement third-party tools and services to manage member histories, facilitate internal transitions between groups or units, and inform members of positions within and trainings offered by an enterprise. For example, many enterprises employ third-party tools to handle employee professional data, human resource/employee census information, their own internal systems for time keeping, and recruiting. Example third-party services may include WORKDAY, TALEO, KRONOS, and the like.

In stage 160, career action data determined in stage 150 may be integrated into manager and member versions of active profiles based on respective CTR-elements and a visibility setting for each of the active profiles. The visibility setting within a member profile corresponds to a member's access to, and the amount of, information regarding positions and development offerings that are not strictly relevant or part of the member's current career tracks. In one example, this setting may be adjusted by a member's manager so the managed member focuses on those positions and development offerings that align with the objectives of the manager, the group the member is apart of, or programs or contracts the member is involved with.

At stage 170, a request to view at least one active profile may be received, for example through a user interface for a computing device, from a requestor operating the computing device. As a result of the request, a version of the active profile requested may be displayed based on a user type of the requestor and a type of the request.

In one example, the requestor may be a member who does not manage any other members of the enterprise. The system may access that member's active profile and display a member module that includes a member version of that active profile.

In another example, the requestor may be a manager that manages multiple members, including other managers. A manager module may be displayed by the system in stage 170 and include an option to select a member mode or a program mode depending on: (1) the type of request submitted; and (2) the programs and members the manager is involved with and manages. In one example, the type of request in stage 170 could be a single-member request, where a manager specifies a single member. The manager could then select the member mode or the program mode. In a member mode, a manager version for a member that is the subject of the request may be displayed in the manager module. In a program mode, at least one program that involves the manager making the request and the member that is the subject of the request may be displayed. In one example, the member may be highlighted or otherwise identified in some way in response to the single-member program mode request. In another example, a response to a single-member program mode type of request may include a summary of the member's performance with respect to that program (e.g., start date, percent of billings, hours billed, career progression specific to that program, etc.).

In another example, the type of request in stage 170 could be multi-member profile request. A manager may submit a profile request with regards to a program for which multiple members managed by the manager may be involved. Hence Stage 170 in FIG. 1 includes “at least one active profile” because a request for a program may constitute a request for two or more member profiles. In one example, the multi-member (program) type of request may be submitted by a manager through a selection of a program option presented in the manager module as it displays a manager version of a member's profile in a member mode. In another example, the single-member request type may be submitted by a manager through a selection of one of several options, each corresponding to a member, presented in the manager module as it displays program information.

It will be noted that the exemplary method of FIG. 1 is applicable to situations where active profiles have already been generated and are being stored on a management or dedicated server or other type of data storage repository that is discretely, or otherwise serves as, part of an infrastructure of a computing system for an enterprise. In this example, the exemplary method of FIG. 1 may be employed to update active profiles when an event involving a CTR-element occurs (e.g., a member completes a course or obtains a new certification). Though titles may be disregarded, programs or contracts a member may be involved with, and managers that a member may report to, may be included as CTR-elements in a member's active profile. Accordingly, when a member gets a new manager or starts on a new program, an update to his or her active profile may be performed.

Continuing with the example of an enterprise with existing active profiles, the exemplary method of FIG. 1 may be employed to build an active profile for a new member of an enterprise. In this scenario, the new member's history may define the raw info in stage 110. For the purposes of carrying out stages 120, 140, and 150, any titles or positions held by that member may not be used, or may be subordinated to other CTR-elements as described with reference to stage 140. In this way, aspects of the new member's capabilities, which are reflected by any certifications, skills, previous job responsibilities, clearances, and/or the like, take precedence in determining career tracks based on enterprise initiatives and goals.

In another example, the exemplary method of FIG. 1 may be employed with an enterprise that has not established active profiles for its members. In this situation, like the creation of an active profile for a new member, member histories stored on enterprise servers and/or managed by human resource departments, may be made available to, for example, a system backend. A CCM service implemented by the system backend may build active profiles from the raw info of the member histories for each member or select members as part of an initial implementation. In this situation, the exemplary method may also include installing CCM agents on enterprise servers and/or member user devices.

In one example, a system backend may install CCM agents or cause them to be installed on servers or user devices for an enterprise based on permissions established and enforced by a management service being implemented by an enterprise backend. Furthermore, information from third-party services used or integrated with a computing system infrastructure for an enterprise may be made available or accessed based on permissions established and enforced by an enterprise backend via a service-level agreement (“SLA”) or multiple SLAs. Access and availability of this third-party info may also be governed by SLAs between an enterprise and the third-party service providers.

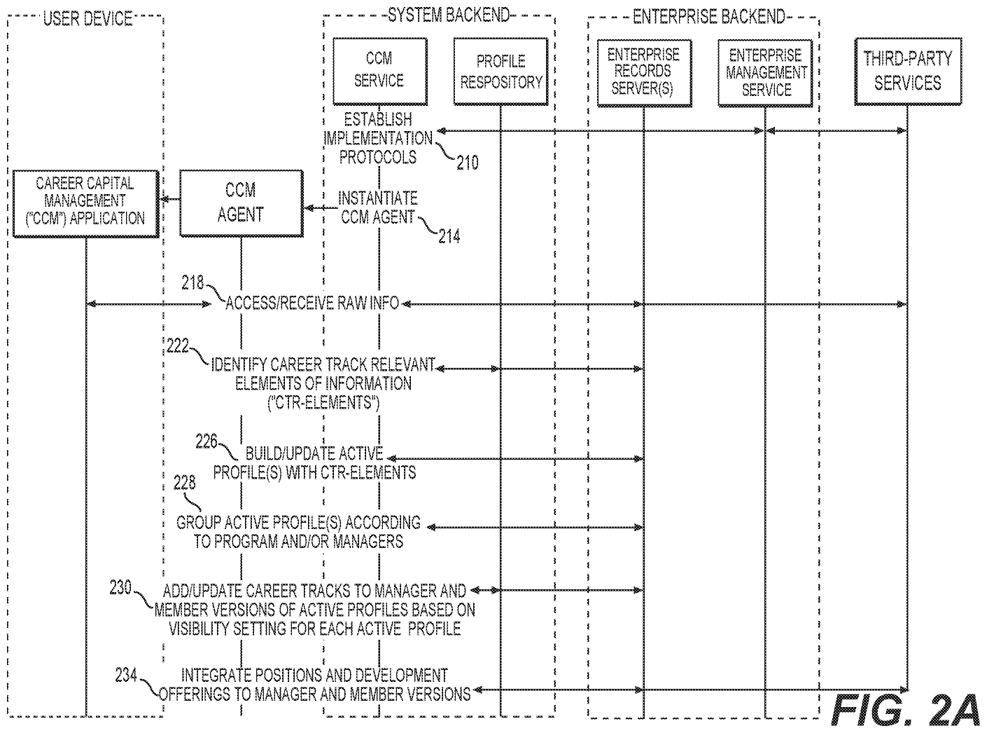

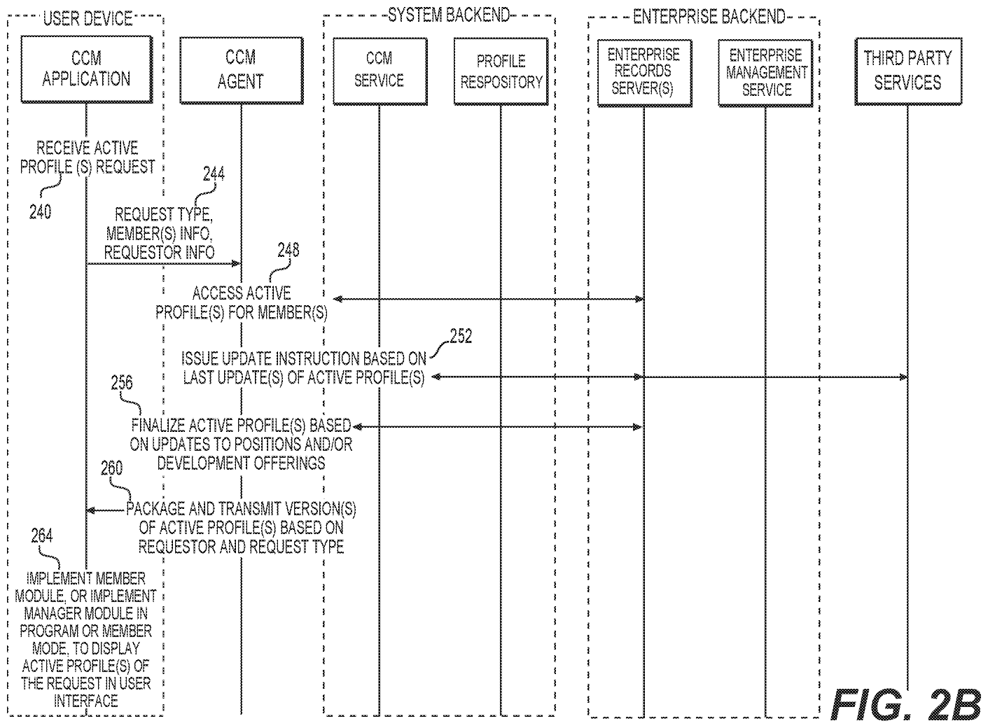

FIG. 2A is a sequence diagram of an example method for dynamically and collaboratively managing enterprise career capital. At stage 210, a CCM service implemented by a system backend may establish implementation protocols for generating and updating active profiles. This includes protocols for delivering information that conveys how members are progressing along one or more career tracks, and how, or if, their respective career capital and career progressions may be in alignment with goals for respective groups, units, contracts, or programs the members are part of or involved with. In addition, stage 210 includes establishing protocols for selectively delivering information regarding when members are anticipated to lose coverage (e.g., no longer bill time to) from a contract or program they are currently involved with. Along these lines, the protocols established in stage 210 may deal with selectively delivering information with regards to prospects or a potential to have prospects for gaining coverage that members may have (also referred to as “mobility”).

In one example, establishing implementation protocols may include determining where a CCM agent(s) will be implemented. In one example an implementation protocol may call for a single CCM agent to operate or execute on a management server of an enterprise backend. In another example, CCM agents may be installed along with CCM applications on enterprise owned or managed devices used by members. In yet another example, both the enterprise backend and computing devices used by members may have CCM agents installed or otherwise implemented thereon.

Implementation protocols may be established between the system and enterprise backends according to permissions specifically granted to a system of the present disclosure that is configured to dynamically manage enterprise career capital, which may include managing member progressions through career tracks.

In stage 214, the CCM service may instantiate CCM agent(s) per the implementation protocols established in stage 210.

Stages 218, 222, 226, 228, 230, and 234 described below, may be carried out by a CCM service, a CCM agent, or a combination of both, unless otherwise indicated. In one example, a distribution of processes carried out by these components may be set according to the implementation protocols established in stage 210.

At stage 218, raw info may be received or accessed from a user device, enterprise records servers, and/or third-party services. At stage 222, the CCM agent, or the CCM service, or combination thereof may parse the raw info and compare it to CTR-elements included in repository profiles stored in a profile repository maintained by, or otherwise part of, the system backend, and/or a repository of active and/or archived profiles maintained by the enterprise records servers. In stage 226, active profiles may be built or updated with the CTR-elements identified in stage 222. At stage 228, active profiles may be grouped, tagged, organized, or otherwise associated with a contract or program that a member is involved with/bills time to, and/or managers that member works for in some capacity, whether on those contracts or programs or in some other capacity.

At stage 230, the profile repositories accessed to identify CTR-elements may be accessed again for identifying career tracks to add or update in the active profiles. In one example, the CCM agent or the CCM service may recognize combinations of elements in an active profile that match, or are similar to, combinations of elements in other active profiles or profiles included in the profile repository of the system backend.

In one example, each active profile may include a field or setting (hereafter referred to as “visibility setting”) that is populated or set by a manager or enterprise administrator with a value. The value may be recognized by the system as a level of visibility granted to a member with respect to his or her entire active profile. In on example, a full active profile for any member of an enterprise may include career tracks that are not applicable or may not be pursued should that member remain on a current contract or in his or her current unit, group, or program within an enterprise. Furthermore, a full active profile may include positions a member is qualified for or is on track to be qualified for, that are not positions for that member's group, unit, or division within an enterprise, and is not part of that group's goals or strategic planning. In addition, a full active profile may include development offerings that are not applicable to positions within, or goals and markets that are the focus of, a member's enterprise group(s), unit(s), program(s), or current contract(s). This is in part due to career tracks and development offerings being identified in stage 230 based on the position-independent CTR-elements included in an active profile.

Each active profile created and maintained by a system according to the present disclosure may include a member version and a manager version of that member's profile. A manager version will include all career tracks, positions, and development offerings that could be options for a member to acquire career capital and advance the member's career progression within an enterprise based on the CTR-elements associated with that member. The member version, may only include those career tracks, positions, and offerings that a member's manager or an enterprise wants the member to see.

An active profile's visibility setting may dictate whether a member may view all of the career tracks, positions, and/or development offerings that have been included in that member's active profile. More specifically, these are careers, positions, and/or offerings that the system has determined to be relevant career capital and options for a possible career progression within the enterprise by that member.

In one example, an enterprise or a manager for a member's group within an enterprise, may employ management strategies that direct managed members to obtain career capital that align with certain goals and objectives of that group or the enterprise. As a result, the manager may desire to limit the amount of information about positions and development offerings that a member is informed of through the CCM application so that the member remains focused on those activities that benefit the group the most. Accordingly, the manager may set a visibility setting for the active profiles of members that her or she manages to that of a restricted status.

In another example, the manager or enterprise may employ a policy of complete openness and set visibility settings for active profiles of a member to be unrestricted. Under this construct, managed members may be informed through the CCM application of all relevant opportunities. That is, with their respective member version of their active profile, the member may view any and all career tracks, positions, and offerings that, based on the CTR-elements associated with a particular member, have been determined to be part of a potential career track for the member within the enterprise. Thus, in stage 230, the CCM agent or the CCM service may check a visibility setting for each active profile being updated or created, and populate the different active profile versions according to what a manager or the enterprise wants the member to be informed of

One of ordinary skill in the art will readily recognize that members of an enterprise that manage other members, referred to as “first managers” for the purpose of this example, may also be managed by other members (“second managers”). In one example, a second manager may access a manager version of an active profile for a first manager that he or she manages using a manager module. The system according to the present disclosure may provide the second manager with an option within the manager module to restrict what range of visibility settings are available to the first manager to set in the manager versions of active profiles of members the first manager manages.

Continuing with first and second manager example, a range of visibility settings for an enterprise could include unrestricted, enterprise-focused, enterprise group-focused, and contract or program-levels of visibility. An unrestricted level would result in all relevant career tracks, positions, programs, and development offerings being included a member version of an active profile. An enterprise-focused level could include those tracks, positions, programs, and offerings that apply to a group a member that is part of and any markets an enterprise competes in or is considering entering. The group-focused visibility setting may result in a CCM agent or the CCM service including only those tracks, positions, and offerings that align with a group's objectives, as identified by, for example, the first manager, the second manager, or a member within the enterprise both managers report to. The contract or program-focused visibility setting may result in a CCM agent or the CCM service including only those tracks, positions, and offerings provided for by a program or contract a member bills to or is otherwise involved with. Thus, the second manager may set a visibility range setting within the manager version for the first manager to a value that only permits the first manager to select a group-focused visibility level within the manager versions of active profiles for members directly managed by the first manager.

At stage 234, the CCM agent or the CCM service may access the enterprise records servers and the third-party services to identify positions, programs, contracts, and development offerings relevant to the career tracks within the manager version of the active profile (i.e., all career tracks in the active profile regardless of a visibility setting) added and/or updated in stage 230. This may include obtaining scheduling information (e.g., when a position will be open, dates for development offerings, duration, etc.), eligibility requirements, internal permission or enrollment request procedures, cost, clearance requirements, points of contact, application documents, and other information that a member could use to take some type of action with respect to a particular position or development offering directly from his or her user device via the CCM application.

FIG. 2B is a sequence diagram of an example method for providing access to an active profile for a member.

At stage 240, the CCM application may receive a request for one or more active profiles. The request may be received through a user interface of a user device where the CCM application is running. In one example, the CCM application may cause a member or a manager module to be presented by or through the user interface. In another example, a type of module for display may be selected when a member logs into a user device, the user interface, or the CCM application. In an example in which a CCM agent is implemented on the user device, an access protocol may be managed by the CCM agent which enforces security measures pushed down to the CCM agent from an enterprise management service executed by an enterprise backend.

The request in stage 240 may be a single-member request (i.e., a single active profile) that is submitted by a member or a manager utilizing a member module. In another example, the request for one active profile may be submitted by a manager utilizing a manager module in a member mode. In yet another example, the request for one active profile may be submitted by a manager utilizing the manager module in a program mode. In particular, the manager may select a single member indicated as being involved with a program for which information, such as a roster of members, is being displayed by and within the manager module (in a program mode).

On the other hand, the request received in stage 240 may be a multi-member request in which a manager requests access to the active profiles of members involved with a particular program or contract or that the manager otherwise manages. This request may be submitted utilizing the manager module in a program mode. In another example, this type of multi-member request may be submitted by a manager as he or she views a manager version of another member's active profile utilizing the manager module in the member mode, and selects an option to access a program or contract that a member is involved with, or a group or unit the member is a part of and for which the manager has some managerial authority.

In stage 244, the CCM application may forward information regarding, or otherwise identify, a member or members corresponding to the at least one active profile requested in stage 240. In addition, the CCM application may transmit an identity of the requestor of the at least one active profile, and a type of the request. As discussed above with respect to stage 170 of the exemplary method of FIG. 1, active profile requests may be submitted by members and managers, and managers may submit single-member (member mode) and multi-member (program mode) types of requests for active profiles. In addition, a manager may submit at least two types (sub-types) of a single-member request—a member mode request or program mode request. In some examples, the information transmitted in stage 244 may be required by the CCM agent to ensure members are not allowed to access active profiles for members other than themselves and which they do not manage.

At stage 248, one or more active profiles corresponding to the at least one active profile requested in stage 240 may be accessed by the CCM agent. In one example, the one or more active profiles, along with other active profiles for members of an enterprise, may be stored on a storage server included as part of a computing system infrastructure for an enterprise. In another example, the active profiles may be stored in a cloud-based storage solution employed by an enterprise. In still another example, a management server on which an enterprise management service is implemented, may include a database where active profiles are stored and accessed.

At stage 252, the CCM agent checks update records pertaining to the one or more active profiles accessed in stage 248 to determine an amount of time since a most recent update for any of the one or more active profiles. In one example, if more than a predetermined amount time has elapsed since the last time any of the one or more active profiles received an update, the CCM agent or the CCM service may issue an update instruction in stage 252. This is especially done where the request in stage 240 includes a request for active profiles of members involved with a program or are otherwise define a group of members managed by a manager who submitted the request in stage 240.

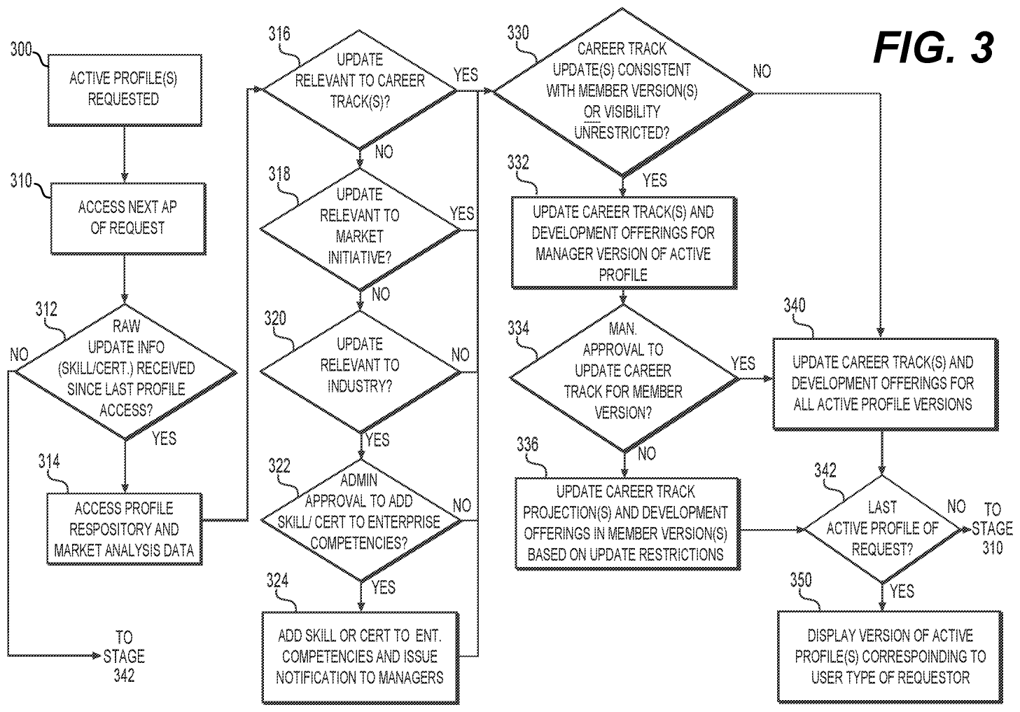

In one example, as explained in more detail with reference to FIG. 3, the update instruction may include instructing or querying the enterprise records servers and third-party services using career tracks in a current active profile. The CCM agent may receive responses from the records servers and third-party services that include new, renewed, or revised positions or development offerings relevant to the career tracks that were the subject of the query. In identifying the new, renewed, or revised CTR-elements, the CCM agent may either directly modify the active profile to include these elements, or submit the elements to the enterprise management service that either modifies or instructs a service operating on enterprise records servers, to update the active profile.

In another example, also explained in more detail with reference to FIG. 3, it may be the case that a member has completed a certification or acquired a skill since the last time his or her active profile was accessed, and has yet to be identified from raw info or otherwise added to the active profile. In this case stage 252 may involve similar operations as performed for stages 226, 230, and 234.

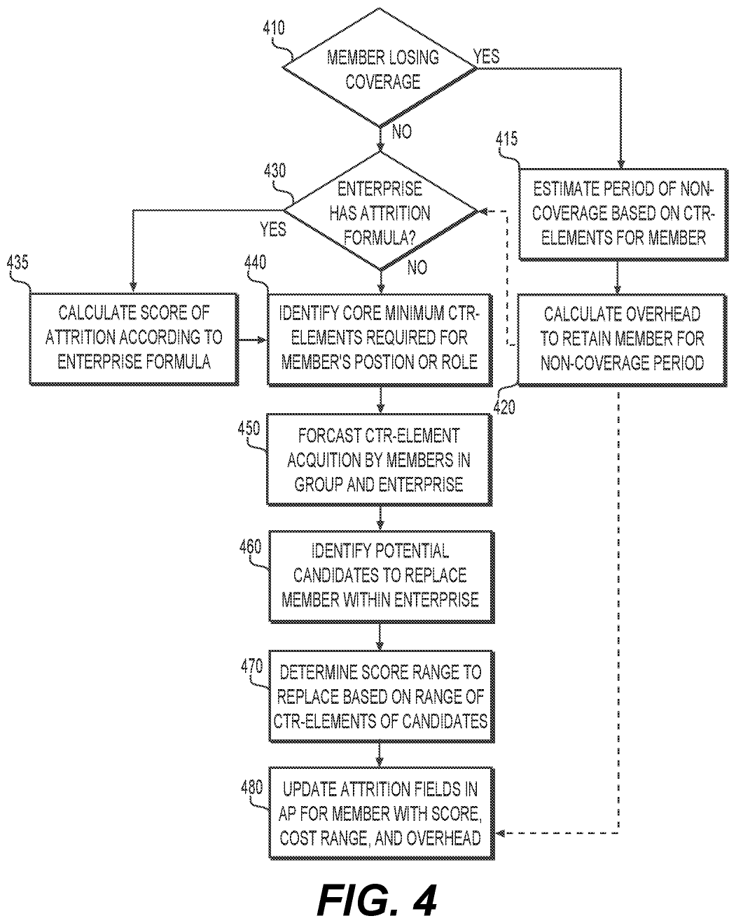

At stage 256, the CCM agent may finalize the one or more active profiles based on the updates identified in stage 252. In one example, finalizing the one or more active profiles may include determining for each, different variables for measuring an impact of member attrition on an enterprise, as explained with reference to FIG. 4. Thus, in one example, stage 256 may include the CCM agent determining and including values for these variables in the one or more active profiles.

In stage 260, in the case of a single-member profile request, the CCM agent may select a version of the relevant active profile for display through the CCM application based on a member type of the individual that requested the active profile in stage 240. Where the requestor is the member for the single active profile requested, the CCM agent may transmit the member profile to the CCM application. In turn, a member module of the CCM application may be enabled to cause the member profile to be displayed in a user interface of the user device in stage 264.

In another example, where a member type of the requestor is a manager member type, and the active-profile requested is not the requestor's active profile, the CCM agent may transmit a manager version of that single active profile to the CCM application. In turn, a manager module of the CCM application, being utilized in a member mode or a program mode as described herein, may be enabled to cause the manager version to be displayed or otherwise presented in the user interface of the user device being used by the requestor in stage 264.

In one example, each unit, group (managed group), program, or contract within or involving the enterprise may also have its own combination of active profiles, or have centralized access to all the active profiles of members (including managers) involved therewith. Thus, in selecting one of these combinations of active profiles in stage 240 through a manager module in a program mode, a manager may request all the active profiles for members that: (1) he or she manages; and (2) are part of the particular group or unit, or involved with the particular program or contract. In addition to a roster of members and centralized access to their active profiles, these combinations of active profiles that are group or program-specific, may include summaries, reports, and other tools. Also included may be information providing or related to an inventory of certifications, skills, clearances, and other CTR-elements possessed by members; program length; group size; group attrition summaries; group mobility summaries; and/or other contract or program details. These combinations of active profiles may be used by managers as forecasting tools as well as an interface for obtaining a summary of the capabilities, career tracks, and career capital including career progressions of the members in that group or involved with that program or contract. In addition, these combinations of active profiles may be used to gain visibility into how member's career tracks may align with goals and objectives for the group, program, or contract managed on some level by the manager accessing that combination of active profiles that are group/unit/program/contract-specific.

FIG. 3 is a flowchart of an example method for building or updating an active profile or combinations of active profiles with respective CTR-elements. At stage 300, a request for one or more active profiles may be received. In stage 310, the CCM agent may access a single active profile of the request, or a next active profile in a combination of active profiles corresponding to the request, from the enterprise records server. At stage 312, the CCM agent may determine if there has been an update to the active profile access in stage 310, since a last that active profile was accessed.

It may be the case that there are no updates to any specific CTR-element already in the active profile, or to any positions or development offerings relevant to any career tracks in the active profile accessed in stage 310. In that case, the CCM agent may check to see if there are any more active profiles to be accessed in stage 342. Where the last active profile of the request has not be accessed, the CCM agent may perform stage 310 as previously described. If the CCM agent determines a last active profile for the request has been accessed, the CCM agent may cause a single active profile or a combination of active profiles to be displayed in stage 350. The versions of the one or more active profiles displayed corresponding to a member type of the requestor and a type of the request submitted.

Where it is determined in stage 312 there has been an update, the CCM agent or the CCM service, having been notified of the update (or generating the notification), may access a profile repository and market analysis data. The profile repositories accessed may be those maintained or managed by a system backend or an enterprise backend. The market analysis data will persist within a server, database, or other data storage component (e.g., a cloud storage service), that is controlled by or part of enterprise servers providing the enterprise backend. The market analysis data may identify markets and requirements to enter those markets from a human capital perspective (e.g., CTR-elements like software certifications and security clearances), with respect to estimated capital expenditure requirements, and/or stemming from geographic considerations.

At stage 316, the CCM agent or the CCM service may determine if the update is relevant to any career track included in the active profile requested. The system may determine if the update is relevant to any particular market initiative by the enterprise in stage 318 based on a determination that the update is not relevant to a career track in stage 316. At stage 320, an analysis of whether the update is relevant to an industry that an enterprise is part of may be performed. In one example, the system may reach this stage upon determining that a member of the enterprise has acquired a skill or obtained a certification that is not relevant to any market initiative the enterprise may be interested in pursuing or career track that any enterprise member could pursue within the enterprise.

In instances where it is determined that the update is relevant to an industry, in stage 320, the CCM agent or the CCM service may check with an enterprise management service with respect to adding the CTR-element that is likely a skill, certification, or clearance of some type, to list of competencies possessed by the enterprise as a whole. This list of enterprise competencies may be made available to managers accessing their program or unit's combination of active profiles utilizing a manager module in a program mode. In one example, stage 322 may include determining if admin approval is required to add the CTR-element. In another example, stage 322 may include implementing a protocol to place an admin on notice of the CTR-element and request authorization to adding it to competencies for the enterprise.

In stage 324, with admin approval obtained or determined to be unnecessary, the new CTR-element, likely a skill or certification, may be added to a list of competencies both for the group for a member corresponding to a profile requested, as well as the a list of competencies for the enterprise. Further, a notification may be transmitted, by or through the CCM agent (and approved by the enterprise management service), and delivered to managers of the enterprise.

The CCM agent or the CCM service makes a determination in stage 330 after the update identified in stage 312 is determined to be: relevant to a career track in stage 316; or relevant to a market initiative in stage 318; or not relevant to an industry in stage 320; or not approved for addition to competencies in stage 322; or added to the competencies in stage 324. In particular, at stage 330, the CCM agent or the CCM service may check to determine: (1) whether a career tack update is consistent with a member version of the active profile requested; or (2) that a visibility setting for that active profile is unrestricted. In the event neither of those criterium is true, career tracks, positions, and development offerings may be updated in the manager version of the active profile in stage 332. On the other hand, where it is determined that either of those criterium are true in stage 330, the updated career track(s), positions, and development offerings may be included in the member and manager versions of the active profile in stage 340.

Stage 340 may also be executed where it is determined in stage 334 that a manager for a member of the requested active profile has approved the addition of the update to the member version. This may occur upon a request from the member. In another example, a notification may be sent by the CCM agent to a manager automatically, and include the update and any other CTR-elements associated with the update. Otherwise, in stage 336, the member version of the requested active profile may be updated in accordance with the visibility setting for the active profile requested. Upon completion of stage 336 or 340, the CCM agent may determine if any more active profiles associated with the request that still need to be accessed in stage 342 as previously discussed. Accordingly, following the update in stage 336 or 340, the CCM agent may perform stage 310, or cause a single active profile or a combination of active profiles to be displayed in stage 350.

FIG. 4 is a flowchart of an example method for measuring and characterizing potential impacts to an enterprise from member attrition using a system of the present disclosure. In stage 410, the system may review an active profile that has been requested to determine if and when a member for the active profile is going to lose coverage. In one example, coverage may refer to whether the member is on a contract or is generating revenue for an enterprise. Coverage may be defined another way or based on another trackable metric for certain members that are traditionally not revenue generators (e.g., members in administrative or human resources types of positions).

In stage 415, a CCM agent or the CCM service estimates a period of non-coverage for the member based on CTR-elements for that member, previous periods of non-coverage, and existing contracts being serviced by the enterprise. Using this estimated period of non-coverage, in stage 420, the CCM agent or the CCM service determines an overhead head amount to retain the member over the non-coverage period. In one example, overhead may equal the member's compensation and benefits over the estimated non-coverage period of time. In another example, the system may automatically perform stages 415 and 420 as a rule. In yet another example, stages 415 and 420 may be executed due to a recognition by the CCM service of a type of contract that a member is currently on being one that may end abruptly. This determination may be a product of machine learning implemented by the CCM service.

Subsequent to calculating the overhead in stage 420, the system may check for an attrition formula in stage 430 or update an active profile in stage 480 based on how the system is configured. In one example, an enterprise may want to know the impact (e.g., cost) of losing a member who is going to lose coverage versus an impact (e.g., cost) of continuing to retain that member. The system may be configured to evaluate these two factors over, for example, a year's worth of time where in a first scenario, the member is not retained and then replaced with an individual possessing comparable CTR-elements, versus, in a second scenario, the member is retained, loses coverage for the estimated non-coverage period of time and then gets coverage (e.g, goes on contract) or moves to a non-revenue generating position.

In another configuration, the system could move directly to stage 480. This may reflect an enterprise's desire to conserve computing and/or monetary resources. In one example the attrition evaluation could require additional computing resources (time, bandwidth, data traffic over a network, etc), or depending on an agreement between the system provider and the enterprise, carry a separate fee every time it is executed. In another example, this configuration may reflect a philosophy or practice of conserving resources (e.g., computing capacity) that are expended on human capital assets that have been identified as less than optimal revenue generators.

Where the system is not configured to automatically perform stages 415 and 420, and the system determines in stage 410 that the member is unlikely to lose coverage, the CCM agent or the CCM service may check to see if the enterprise has its own attrition formula in stage 430. In one example, the CCM agent or the CCM service may base a determination in stage 410 on a threshold minimum projected period of future coverage established for the enterprise when the system is initially implemented. For example, members who are set to be on a contract or several contracts for the next sixth months may be considered in stage 410 as not losing coverage. The threshold may be established or changed through the CCM service. In another example, the CCM service may review coverage history for groups of members and implement machine learning to determine this minimum threshold of coverage time. That is, the CCM service may review past members and continuously monitor current members for coverage and determine that members that have a minimum projected future period of coverage are unlikely to lose coverage because these members are brought on to other contracts or their current contract is of a type that typically extends for a period of time longer than the minimum threshold.

At stage 430, as mentioned above, the system may check for an attrition formula. An attrition formula may be standardized for the enterprise or be group/unit-specific. Accordingly, stage 430 may include the system communicating with an enterprise management service, in one example, to determine if an attrition formula has been instituted or modified since a most recent iteration of measuring and characterizing potential impacts from member attrition. Where an attrition formula is being employed by the enterprise, in stage 435, the CCM agent or the CCM service calculates an attrition score according to the formula for a member(s) whose active profile(s) was requested.

Upon determining that the enterprise does not have an attrition formula in stage 430 or upon calculating the attrition score in stage 435, the system may identify the core minimum CTR-elements that are required for a member's position or role within an enterprise in stage 440. With this information, the CCM service may review active profiles of other members of a group or unit that includes the member whose active profile was requested in stage 450. In addition, based on this, the CCM service may also forecast what CTR-elements are going to be acquired by those other members over a pre-determined period of time in the future in stage 450. At stage 460, the system may identify potential candidates within the enterprise that may be able to replace the member of the requested active profile.

In stage 470, the system may determine a score range to replace the member. In one example, the score range may indicate a cost range. The system determines potential candidates for replacing the member based on CTR-elements attributed to those candidates. The system may be configured to determine a set of CTR-elements within the core minimum CTR-elements that each candidate possesses. The set of CTR-elements is likely to have fewer CTR-elements than the core minimum. As a result, the system may be configured to determine a cost to an enterprise for a candidate to obtain all of the minimum core CTR-elements that are not included in the set (“gap element”). Next, the system may assign an acquisition score to each of the candidates based on which of these gap-elements they need. After assigning these acquisition scores, the system may identify the high- and low-end acquisition scores as the attrition score range for the member whose active profile has been requested. In one example, the attrition score range may be converted into a cost range that a manager may recognize as range of how much it will cost to replace the member and train the member's replacement.

At stage 480, the system may update the attrition fields of the active profile for the member in question. As explained above, the attrition fields may include one or all of the overhead determined in stage 420, the attrition score determined in stage 435, and the attrition score range determined in stage 470.

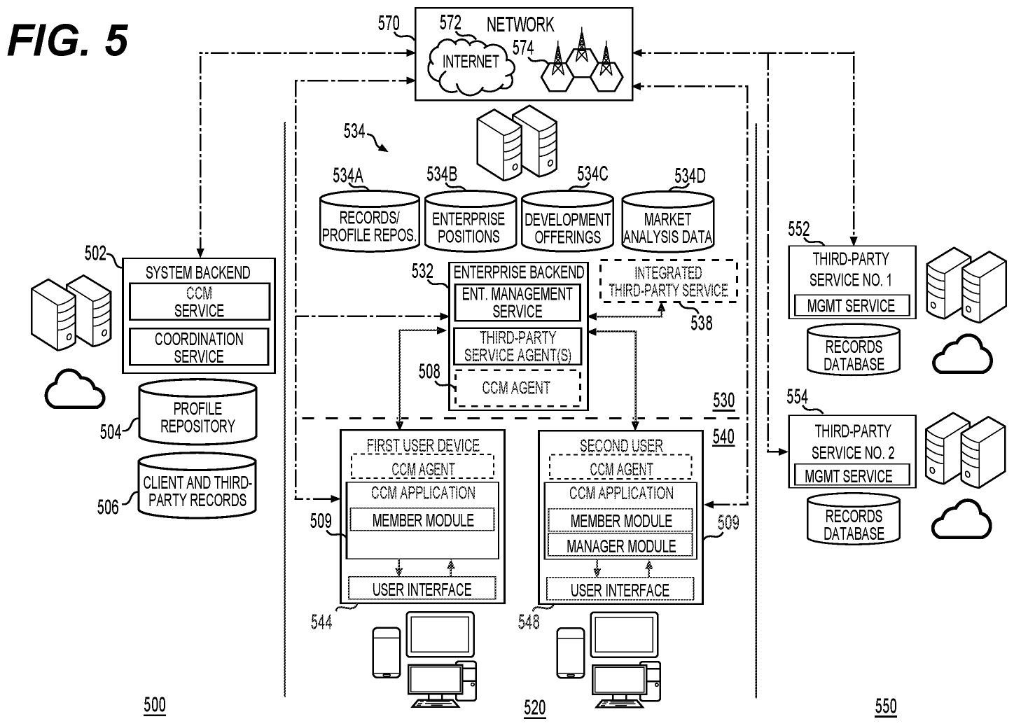

FIG. 5 is an illustration of exemplary components of a system 500 for dynamically and collaboratively managing enterprise career capital.

In one example, the system 500 services an enterprise computing infrastructure 520 as described herein. The enterprise computing infrastructure 520 may include a backend level 530 and an end user level 540. A CCM agent 508 may be instantiated in an enterprise backend 532 of the backend level 530 and/or user devices 544, 548 that are part of the end-user level 540. A CCM application 509 for the system 500 may be installed by the CCM service and/or CCM agent(s) 508 on the user devices 544, 548 as shown.

The system components 500 may include a system backend 502, a profile repository 504, and a database 506 including client (enterprises) and third-party records (third parties that provide organizational, resource, and workforce management related services to the clients). The system backend 502 may implement a CCM service and a coordination service. The CCM service may be configured to perform stages for dynamic and collaborative career capital management as described herein. The coordination service may be implemented for those enterprises that have CCM agents 508 of the system 500 installed on members' user devices, in addition to a CCM application 509 of the system. The CCM agents 508 installed on the user devices 544, 548 may be in addition to, or instead of, a full implementation of the CCM agent 508 on an enterprise backend 532.

Each of the system backend 502 and enterprise backend 532 may include one or more physical servers, and or cloud-based virtual servers that support the services and agents operating on other system components. In addition, both backends 502, 532 may be provided with software-based tools supported or otherwise controlled or implemented by the system backend 502 and through which an administrator may monitor, manage, update, and modify aspects of, for example, a CCM agent being implemented on one or more user devices.

Each of the services running or otherwise being implemented on the enterprise backend 532 may be configured to be compatible with a software product that is at least partially provided by the system backend 502. The software product (e.g., CCM agent) may provide tools for system management, communication and coordination, generating components of and supporting selections made through a user interface, and any other relevant features.

In one example, CCM agents 508 may communicate directly with a coordination service of the system backend 502 through a network 570. The network may include the internet 572 or other network level communication systems such as cellular systems 574. In this configuration, the coordination service may field requests from the CCM agents 508 and determine if communication with an enterprise management service is required for a CCM service to fulfill the request, or requires restricted data to perform a process of the request. In this way, the coordination service may handle communications that may otherwise burden the CCM service and affect speed and quality of its operations. In another example, the CCM agents 508 may be tasked with many of the operations required of the exemplary methods described herein, such as, for example, identifying CTR-elements.

The profile repository 506 may include profiles that the CCM service references to identify CTR-elements. In another example, the profile repository may include a list of CTR-elements. The CCM service, or a CCM agent 508 through the coordination service, may compare raw info received or accessed to the profiles in the profile repository to identify CTR-elements. In another example, either of the CCM service or the CCM agent 508 may compare a package of CTR-elements in an active profile to combinations of CTR-elements in the repository profiles to identify career tracks for members.

The client and third-party records database 508 of the system 500 may store active profiles for an enterprise (client) and be updated in the same way that active profiles are maintained by an enterprise backend (after generation by the HMC service and CCM agent(s)). In addition, based on terms of agreements (e.g., SLAs) and data access permission schemes between the system backend 502 and the enterprise backend 532, and between the enterprise backend 532 and its third-party services 538, 552, 554, the system backend 502 may have direct or indirect access to some portions of third-party-specific member information. In another example, the system backend 502 may have access to third-party service information that is independent of members (e.g., training schedules set by a third-party).

The CCM application 509 may implement member and manager modules on the user devices. In one example, the CCM application 509 may be a web application that is accessed on demand by members. In another example, the CCM application 509 may be a dedicated application installed on the user devices. The member module and manager modules may include graphical user interface (“GUI”) pages or groups of pages (e.g., GUI consoles, dashboards, etc.) specifically configured to present a member version of an active profile, or a manager version in a member mode or a program mode, for display on a user interface of a user device. In one example, a CCM application 509 for a member of an enterprise that does not manage another member may only include, execute, or have access to a member module, as shown with the first user device 544 of FIG. 5. On the other hand, a CCM application 509 for a member that is a manager within the enterprise may be configured to access both types of modules as with a CCM application 509 running on the second user device 548 in FIG. 5.

During operation, the CCM agent 508 or the CCM service may access enterprise records 534 to generate and/or modify/update active profiles for members of the enterprise. In one example, the backend level 530 may include a dedicated database and/or storage server for different types of information. In the example of FIG. 5, the enterprise records 534 includes: a database and/or storage server for member records including active profiles 534A (“active profile server 534A); open positions for the enterprise (“positions server 534B”); development offerings for training, certifications, skill acquisition, and the like (“development server 534C”); and market analysis data that is used for business development (“market data server 534D”). In one example, queries that members submit to the system 500 through the CCM application result in the CCM agent 508 searching through these records, or sending a request to an enterprise backend 532 that searches these records.

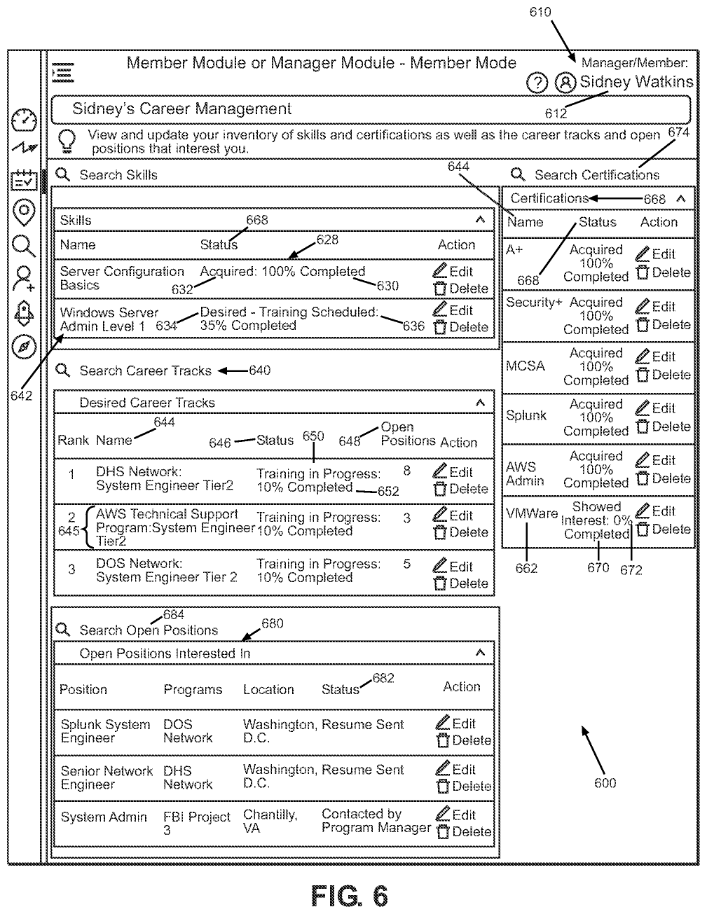

FIG. 6 is an illustration of an example GUI 600 of a career management page 600 for a manager or member module in a member mode, that may be used to perform the various methods described herein. As shown, the career management page 600 may include skills, career track, certification, and open position sections 620, 640, 660, 680.

The skills section 620 may include a list of skills for an individual 612 listed in an ID section 610 and corresponds to a member or manager associated with the member or manager module displayed. More specifically, the skills section 620 can include a list of skills the individual 612 has acquired, is in the process of acquiring, is scheduled to acquire, or is planning to acquire. In one example, a skill entry 622 can include values for a skill identifier 624 and a skill acquisition status 626. In the case of the latter, a status value 628 may include a component that indicates the individual's progress in acquiring a skill with a completion percentage 630, and a component that provides additional information 632 pertaining to ultimate skill acquisition by the individual.

In one example, the completion percentage 630 may be calculated by a service or agent, such as a CCM service or a CCM agent as mentioned above, as part of processes described herein that relate to identifying CTR-elements, building active profiles, and determining active career tracks. The additional information 632 may include a characterization component 634 (e.g., desired, required, acquired, showed interest) a selectable component 636 that indicates that training for the skill corresponding to the skill entry 622 is scheduled, in progress, or available. Values for the additional information 632 may be derived from CTR-elements identified from, for example, member or manager surveys or assessments included as part of an individual's raw profile information.

In the exemplary career management page 600 illustrated in FIG. 6, the selectable component 636 for the skill acquisition status 626 of the skill entry 622 includes a text element “Training Scheduled.” In one example, the text element may be selected to cause a pop-up window or other object to be generated within the career management page 600 and display a name, time, date, duration, and skill acquisition percentage value for a training associated with the text element within an active profile for the individual 612 (member or manager) corresponding listed in the ID section 610.

Just above the skills section 620, the career management page 600 may include a skill search option 638. Selection of the skill search option 638 may cause a text box for searching, and a list of skills that may be relevant to career tracks associated with the individual 612 (or generally relevant to the individual), to be displayed or otherwise presented. In one example, performing a skill search may include entering or selecting a skill, and results tailored to the individual 612 being generated and displayed within the career management page 600. Skills can be searched on a basis of name, the individual's completion percentage of those skills, what skills are required for desired positions, what skills will have training offerings in a specified future period of time, and the like.

The career track section 640 may include a list of career tracks that the individual for the displayed member or manager module is currently on, has expressed interested, has been identified by a manager as a potential career track, or has been matched with based on the CTR-elements identified for that individual (including any career tracks identified from self-assessments or manager assessments). In one example, a track entry 642 can include values for a track identifier 644, progression status 646, and open positions 648 within an enterprise that relate to or further the individual's progress on, a career track 645 displayed in the track identifier 644 for that track entry 642.

In one example, a value for the track identifier 644 may correspond to a highest level or final position in a series of positions within the enterprise that an individual must be promoted to, or otherwise perform the duties of, to be considered as having completed a given career track.

A value for the progression status 646 may include a component that indicates the individual's progress along a career track with a track completion percentage 652, and a component that provides track additional information 650 pertaining to ultimate career track completion achievement by the individual. The track completion percentage 652 may indicate the individual's progress in being promoted to or holding certain positions, or being assigned certain responsibilities, or reached certain levels of management (“moving through the ranks”), required to be on, complete, or be considered in the process of completing a specified career track. The track completion percentage 640 may be calculated by a service or agent, such as a CCM service or a CCM agent as mentioned above, as part of a process of identifying CTR-elements, building active profiles, and determining active career tracks as part of system operations and methods described herein. The track additional information 650 may include a value that characterizes the individual's current active involvement in pursuing a career track (e.g., training in process, on hold, re-evaluating, etc.) values for the track additional information 650 may be derived from CTR-elements identified from, for example, member or manager surveys or assessments included as part of an individual's raw profile information.

Regarding the open positions category for the career track section 640, a value for this category may correspond to a total number of open positions within an enterprise that: (1) the individual is qualified to fill and may advance the individual on a career track corresponding to the career track identifier 644 of the track entry 642; or (2) are part of a group of positions the individual must hold to be on the career track; or (3) may satisfy a next step in the individual's career track.

Just above the career track section 640, the career management page 600 may include a track search option 654. Selection of the track search option 654 may cause a text box for searching, and a list of career tracks that may be relevant to the individual 612, to be displayed or otherwise presented. In one example, performing a track search may include entering or selecting a career track, and results tailored to the individual 612 being generated and displayed within the career management page 600. Career tracks can be searched on a basis of name, the individual's completion percentage of those skills, what skills or certifications are required for desired career tracks, what career tracks will have skill or certification training offerings in a specified future period of time, and the like.

In a similar fashion to the skills section 620, a certification section 660 may include a list of certifications that an individual for the displayed member or manager module has acquired, is in the process of acquiring, is scheduled to acquire, or is planning to acquire. In one example, a certification entry 662 can include values for a certification identifier 664 and a certification acquisition status 668. In the case of the latter, a status value 670 may include a component that indicates the individual's progress in acquiring the certification with a completion percentage 672.

Just above the certification section 660, the career management page 600 may include a certification search option 674. Selection of the certification search option 674 may cause a text box for searching, and a list of certifications that may be relevant to one or more career tracks associated with the individual 612, to be displayed or otherwise presented. In one example, performing a certification search may include entering or selecting a name of a certification, a skill, a position, or a career track, and results tailored to the individual 612 being generated and displayed within the career management page 600. Certifications may be searched on a basis of name, the individual's completion percentage of those certifications, certifications required for particular career tracks and skills, what certifications will have training offerings in a specified future period of time, and the like.

An open position section 680 may also be included in the exemplary career management page 600 as shown. The open position section 680 may include a list of positions that: (1) correspond to all of the open positions referred to in the career track section 620; (2) positions that an individual 612 has expressed interest in; (3) positions the individual 612 has applied for; AND/OR (4) open positions that require the individuals (A) current skills and certifications at the individual's respective levels of completion (e.g., percent complete or acquired); or (B) current skills and certifications at the individual's respective desired levels of completion (e.g., percent complete or acquired); or (C) desired skills and certifications corresponding to the individual's desired career tracks. The open position section 680 can include different categories of information including what program, agency, or division the position falls into, where it is located, and a status category 682 for indicating a stage the individual is in for applying and/or progressing through hiring process for that position.

Just above the open position section 680, the career management page 600 may include a position search option 684. Selection of the position search option 684 may cause a text box and a list of positions to be displayed, or otherwise presented, that may be relevant to the individual 612 listed in the ID section 610. In one example, performing a position search may include entering or selecting a name of a certification, a skill, a location, a program, or a career track; and results tailored to the individual 612 being generated and displayed within the career management page 600. Open positions may be searched on a basis of name, the individual's completion percentage of skills and certifications required for open positions, locations, programs, what certifications and skills that are required for the open position will have training offerings in a specified future period of time, and the like.

Any status shown in the career management page 600, in any of the skills, career track, and certification sections 620, 640, 660, may be based on information identified or determined by a CCM service or agent to be a CTR-element, as part of a process such as stage 120 for the exemplary method of FIG. 1.

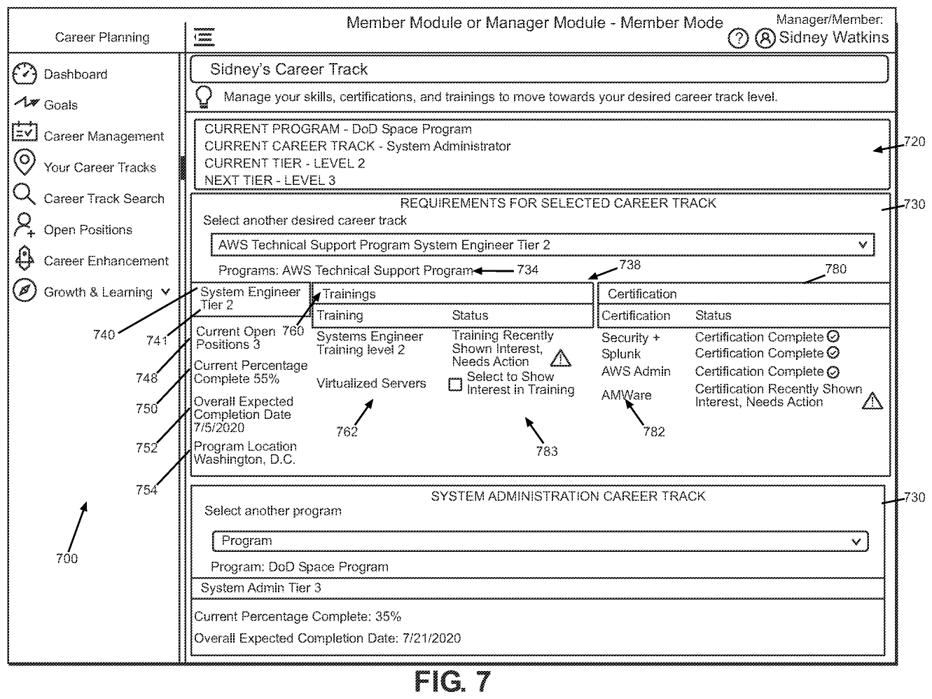

FIG. 7 is an illustration of an example GUI for a career track page 700 or a manager or member module in a member mode. As shown, the career track page 700 includes a summary section 720 positioned above a group of individual career track module components 730. The summary section 720 may identify a current program 722, a current career track 724, current tier 726, and a next tier 728 for an individual 712 listed in the ID section 710 that corresponds to the member or manager the displayed member or manager module is associated with.

Each of the career track component 730 may include a track identifier 732 and one or more program subcomponents 734. Each program subcomponent 734 may include program identifier 736 and a table 738 with a listed career track 740, and training and certification columns 760, 780. The listed career track 740 may correspond to a user's current career track 724 and current tier 726. As shown, the program subcomponent 734 may display a number of open positions 746 related to the listed career track 740, a progress statistic 750, a projected completion 752, and a location 754 for the program identified in by the program identifier 736. A value provided in each of progress statistic 750 and the projected completion 752 may be specific to the individual 712. In particular, the progress statistic 750 may correspond to percentage of a listed tier 741 for the listed career track 740 the individual 712 has completed through positional promotions and/or skill and certification acquisitions. The projected completion 752 may be determined, for example by a CCM service or agent, based on schedules of future skill, certification, and position offerings, and a rate of progress for the individual 712 through the current tier 726.

As shown, the training and certification columns 760, 780 of the table 738 may list various training programs 762 and certifications 782, respectively. These training programs 762 and certifications 782 may be part of the listed career track 740 for the individual 712. Further, a status value for any training program or certification listed may be identified or determined by a CCM service or agent. More specifically, the CCM service or agent may identify or determine that: (A) the particular training program or certification is relevant to the listed career track 740; and (B) there has been some interest or type of activity (e.g., enrollment, full or partial acquisition, manager recommended, listed in an assessment, etc.) with respect to that particular training program or certification, on the part of individual 712 as a member, or the individual's manager, or other individual 712 in an enterprise involved with the individual's career track. This interest or activity may be identified by the CCM service or agent as a CTR-element, as part of a process such as stage 120 for the exemplary method of FIG. 1.

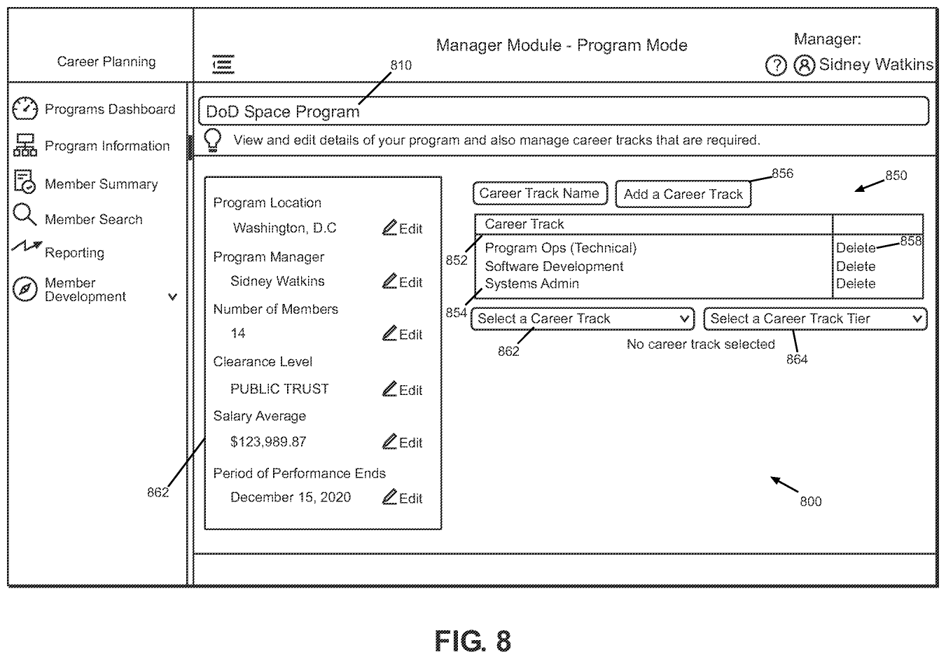

FIGS. 8-12 provide illustrations of example GUIs for a manager module in a program mode. A manager for an enterprise may utilize the program mode to review performance, career track progress, mobility, and other program-specific information for members involved with that program. Further, the GUIs of FIGS. 8-12 illustrate a program mode that may be utilized to review members individually and in the context of a group of which they are a part.

FIG. 8 is an illustration of an example GUI of a program information page 800 for a manager module, in a program mode, that may be used to perform the various methods described herein. The program information page 800 illustrates may include a program identifier 810, program stats section 830 that includes high-level information for the identified program. The stats section 830 can include various aspect of the program, which as shown, may include a number and average salary of members that are involved in the program and managed by the manager accessing the program information page 800. Other stats may include a program location and performance evaluation period end date, as shown, as well as other stats that may include current number of open positions, name of member losing coverage the soonest, total hours billed, and other information.

In addition to the stats section 830, the program information page 800 can include a career track section that is specific to the program names in the program identifier 810, and editable by the manager. More specifically, a manager may add a career track using an add option 856, and delete career tracks with a delete option 858 included with each track entry 854 listed in a track table 852. Adding or removing career tracks to the program may change career tracks associated with members who are part or not part of the program identified with the program identifier 810. In turn, when members access their member mode modules, new or fewer career tracks may appear in a member-specific track section, such as the track section 620 of FIG. 6.

In addition to being able to add and delete career tracks, a user (manager) can search for and filter career tracks associated with the program by career track name 862 and/or tier 864. Selection of a career track from the career track table 852 can result in a career track information page or pop-up being generated, and may include program-specific information for the selected career track. For example, a list of members that are associated with the program and may be pursuing the selected career track may be displayed.

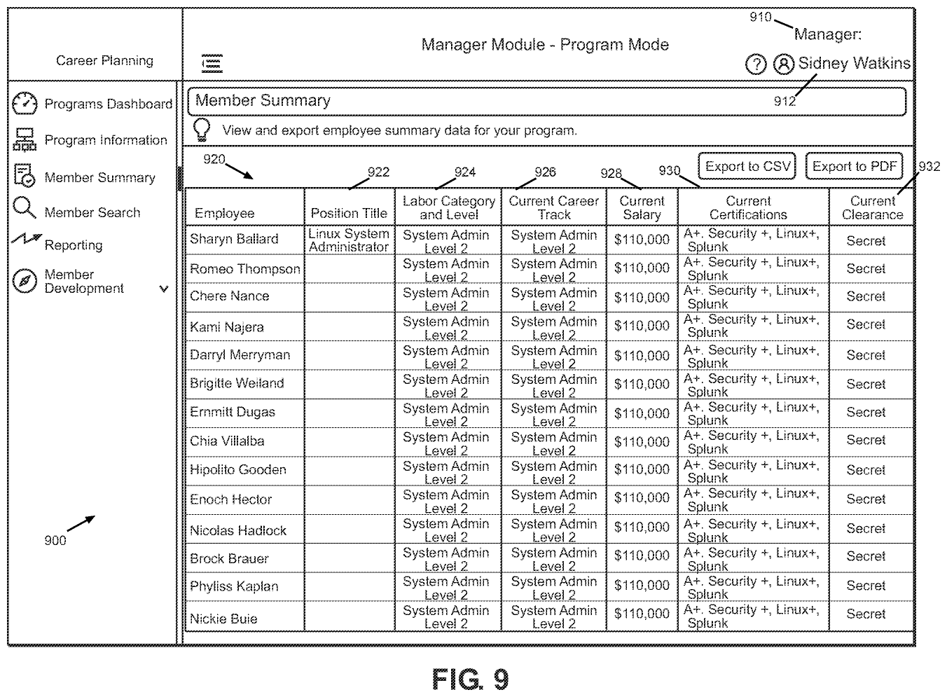

FIG. 9 is an illustration of an example GUI of an employee summary page 900 for a manager module in a program mode according to the present disclosure. As shown, the employee summary page 900 can include a table 920 that lists all the members involved with a program managed by an individual 912 (a manager) identified in an ID section 910. Alternatively, the table 920 may include all the members involved with the program, irrespective of their managers. In yet another example, the table 920 could include a list of members managed by the individual 912 for all the programs the individual 912 is involved with. Member information in the table 920 can include position title 922, labor category and level 924, current career track 926, salary 928, certifications 930, and other information such as clearance level 932 as illustrated.

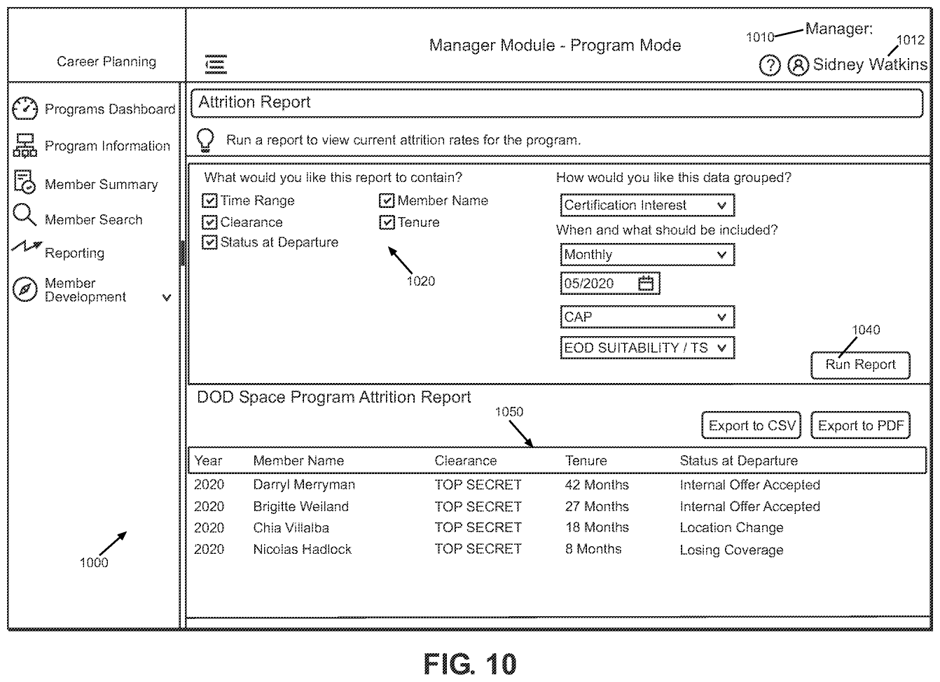

FIG. 10 is an illustration of an example GUI of an attrition report page 1000 for a manager module in a program mode. Utilizing features provide through the GUI, a user may generate an attrition report 1050, which provides members that were previously managed by a manager corresponding to an individual 1012 listed in and ID section 1010, or involved with a specific program for which the attrition report page 1000 may be limited to show through user selections. The user can customize the report to provide information corresponding to certain information categories 1020, as well as how to group and present the results using analysis features 1030. Once particular information categories 1020 and analysis features 1030 are selected by the user, the user can select a run option 1040, and a CCM service or agent can access various information sources, such as those described in connection with FIG. 5, and generate the attrition report 1050 according to the selections made.

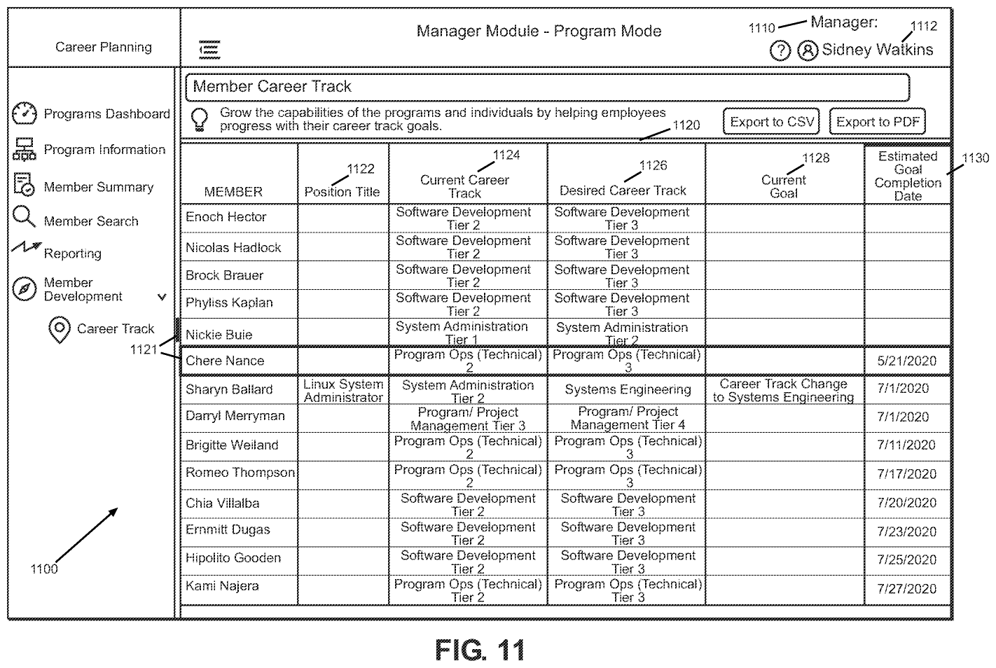

FIG. 11 is an illustration of an example GUI of a career track summary page 1100 for a manager module in a program mode. As shown, the career track summary page 1100 can include a table 1120 that lists all the members involved with a program managed by an individual 1112 (e.g., a manager) identified in an ID section 1110. Other versions of the table 1120 may include all the members involved with the program, irrespective of their managers. In yet another example, the table 1120 could include a list of members managed by the manager for all the programs the manager is involved with. Member information in the table 1120 may include position title 1122, current career track 1124, desired career track 1126, current goals 1128, and estimated goals 1130.

Values for the desired career track 1126 of any of member entries listed in the table 1120, may be part of career tracks those members corresponding to the member entries 1121. In addition, these may be the career tracks a member sees when their specific respective career track page, such as the career track page 700 illustrated in FIG. 7. In another example, a value for the desired career track 1126 may correspond to a career track for which some interest or activity (e.g., enrollment, full or partial acquisition, manager recommended, listed in an assessment, etc.), on the part of a member corresponding to a given member entry 1121, or the member's manager, or another individual in an enterprise involved with that member's career track, has been recognized by, for example, a CCM service or agent. This interest or activity may be identified by the CCM service or agent as a CTR-element, as part of a process such as stage 120 for the exemplary method of FIG. 1.

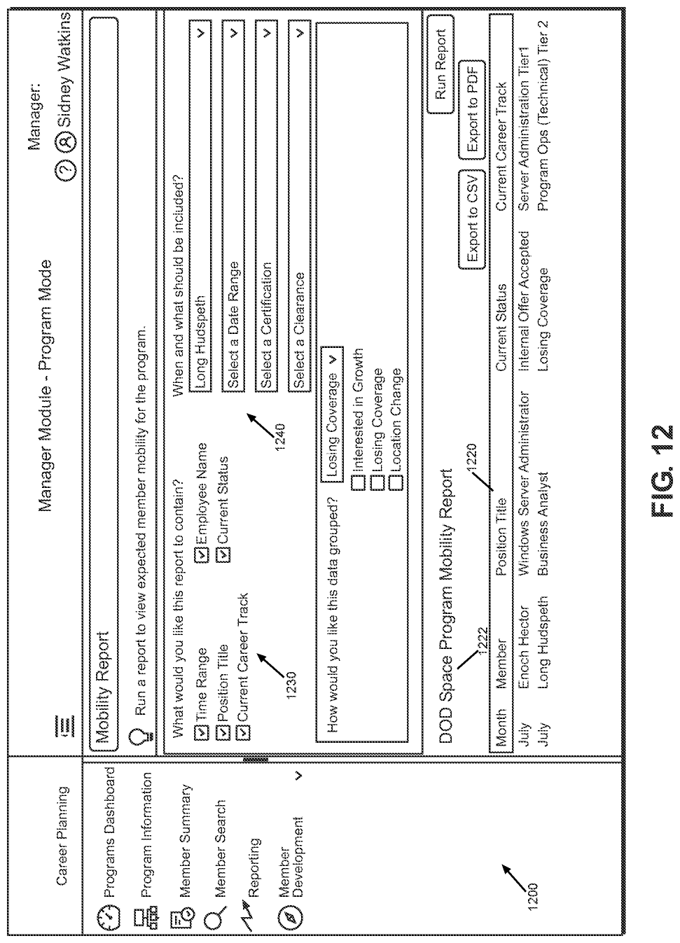

FIG. 12 is an illustration of an example GUI for of a mobility report page 1200 for a manager module in a program mode. The mobility report page 1200, much like the attrition report page 1000, can be used by a manager to generate reports that allow the manager to know when certain members they manage may lose coverage. As shown in FIG. 12 with a program identifier 1222, a generated report may be program specific. In other examples, the manager may generate a report that lists all the members they manage across all the programs the manager is involved with.

It will also be noted that either of the attrition and mobility report pages 1000, 1200 may used by managers of an enterprise that are, or may not be, involved with the programs for which the reports are generated. For example, mobility report page 1200 can be used by a manager interested in bringing on members from one program that manager is not involved with to one that he or she is involved with. At least for this reason, the mobility report page 1200 may include certain information categories 1230, CTR-based filters 1240, and coverage-based analysis features 1250, that a manager can provide values for and use to customize the mobility report 1220.

Other examples of the disclosure will be apparent to those skilled in the art from consideration of the specification and practice of the examples disclosed herein. Though some of the described methods have been presented as a series of steps, it should be appreciated that one or more steps may occur simultaneously, in an overlapping fashion, or in a different order. The order of steps presented are only illustrative of the possibilities and those steps may be executed or performed in any suitable fashion. Moreover, the various features of the examples described here are not mutually exclusive. Rather any feature of any example described here may be incorporated into any other suitable example. It is intended that the specification and examples be considered as exemplary only, with a true scope and spirit of the disclosure being indicated by the following claims.

What is claimed is:

1. A method of dynamically and collaboratively managing enterprise career capital, the method comprising:
causing, with a server, a career capital management agent (“CCM agent”) to be implemented on at least one of a system server and a user device;
accessing raw profile information for a member of an enterprise with at least one of the system server and the CCM agent;
accessing a first profile repository and identifying career track relevant elements (“CTR-elements”) of information from the raw profile information based on first reference profiles included in the first profile repository;
incorporating first CTR-elements associated with the member into a first active profile for the member, the first active profile stored in at least one of the system server and an enterprise server;
accessing at least one of the enterprise server and an external service and identifying career action data based on a first active career track of the first active profile and the first CTR-elements, the career action data including positions and development offerings for the enterprise; and
integrating the career action data into manager and member versions of the first active profile based on the first CTR-elements and a visibility setting for the first active profile.

2. The method of claim 1, further comprising:
determining, prior to accessing the first profile repository, no active profile stored in the at least one of the system server and the enterprise server is associated with the member; and
generating the first active profile from history information for the member, the history information being available from at least one of the system server, the enterprise server, and the raw info.

3. The method of claim 2, further comprising accessing the first profile repository and generating active career tracks for the first active profile based the history information, the first CTR-elements and one or more career tracks included in one or more first reference profiles.

4. The method of claim 1, further comprising:
receiving a request to display, in a graphical user interface (“GUI”), a first active profile; and
displaying one of the member version and the manager version of the first active profile based on a user type associated with the request.

5. The method of claim 4, wherein the one of the member version and the manager version includes a percent complete of a first active career track associated with the first active profile.

6. The method of claim 5, wherein the first active career track includes first positions and first development offerings based on the user type.

7. The method of claim 1, wherein the visibility setting is configured within the manager version of the first active profile.

8. A non-transitory, computer-readable medium containing instructions that, when executed by a hardware-based processor, performs stages for dynamically and collaboratively managing enterprise career capital, the stages comprising:
causing, with a server, a career capital management agent (“CCM agent”) to be implemented on at least one of a system server and a user device;
accessing raw profile information for a member of an enterprise with at least one of the system server and the CCM agent;
accessing a first profile repository and identifying career track relevant elements (“CTR-elements”) of information from the raw profile information based on first reference profiles included in the first profile repository;
incorporating first CTR-elements associated with the member into a first active profile for the member, the first active profile stored in at least one of the system server and an enterprise server;
accessing at least one of the enterprise server and an external service and identifying career action data based on a first active career track of the first active profile and the first CTR-elements, the career action data including positions and development offerings for the enterprise; and
integrating the career action data into manager and member versions of the first active profile based on the first CTR-elements and a visibility setting for the first active profile.

9. The non-transitory, computer-readable medium of claim 8, the stages further comprising:
determining, prior to accessing the first profile repository, no active profile stored in the at least one of the system server and the enterprise server is associated with the member; and
generating the first active profile from history information for the member, the history information being available from at least one of the system server, the enterprise server, and the raw info.

10. The non-transitory, computer-readable medium of claim 9, the stages further comprising accessing the first profile repository and generating active career tracks for the first active profile based the history information, the first CTR-elements and one or more career tracks included in one or more first reference profiles.

11. The non-transitory, computer-readable medium of claim 8, the stages further comprising:
receiving a request to display, in a graphical user interface (“GUI”), a first active profile; and
displaying one of the member version and the manager version of the first active profile based on a user type associated with the request.

12. The non-transitory, computer-readable medium of claim 11, wherein the one of the member version and the manager version includes a percent complete of a first active career track associated with the first active profile,

13. The non-transitory, computer-readable medium of claim 12, wherein the first active career track includes first positions and first development offerings based on the user type.

14. The non-transitory, computer-readable medium of claim 8, wherein the visibility setting is configured within the manager version of the first active profile.

15. A system for dynamically and collaboratively managing enterprise career capital, comprising:
a memory storage including a non-transitory, computer-readable medium comprising instructions; and
a computing device including a hardware-based processor that executes the instructions to carry out stages comprising:
causing, with a server, a career capital management agent (“CCM agent”) to be implemented on at least one of a system server and a user device;
accessing raw profile information for a member of an enterprise with at least one of the system server and the CCM agent;
accessing a first profile repository and identifying career track relevant elements (“CTR-elements”) of information from the raw profile information based on first reference profiles included in the first profile repository;
incorporating first CTR-elements associated with the member into a first active profile for the member, the first active profile stored in at least one of the system server and an enterprise server;
accessing at least one of the enterprise server and an external service and identifying career action data based on a first active career track of the first active profile and the first CTR-elements, the career action data including positions and development offerings for the enterprise; and
integrating the career action data into manager and member versions of the first active profile based on the first CTR-elements and a visibility setting for the first active profile.

16. The system of claim 15, the stages further comprising:
determining, prior to accessing the first profile repository, no active profile stored in the at least one of the system server and the enterprise server is associated with the member; and
generating the first active profile from history information for the member, the history information being available from at least one of the system server, the enterprise server, and the raw info.

17. The system of claim 16, the stages further comprising accessing the first profile repository and generating active career tracks for the first active profile based the history information, the first CTR-elements and one or more career tracks included in one or more first reference profiles.

18. The system of claim 15, the stages further comprising:
receiving a request to display, in a graphical user interface (“GUI”), a first active profile; and
displaying one of the member version and the manager version of the first active profile based on a user type associated with the request.

19. The system of claim 18, wherein the one of the member version and the manager version includes a percent complete of a first active career track associated with the first active profile,

20. The system of claim 19, wherein the first active career track includes first positions and first development offerings based on the user type.
